(19) United States
(12) Patent Application Publication
(10) Pub. No.: US 2024/0231559 A9
(43) Pub. Date: Jul. 11, 2024

(54) THREE-DIMENSIONAL PROGRAMMING ENVIRONMENT

(71) Applicant: Apple Inc., Cupertino, CA (US)

(72) Inventors: Scott Bassett, Cupertino, CA (US); Tyler L. Casella, Martinez, CA (US); Benjamin B. Loggins, San Francisco, CA (US); Amanda K. Warren, London (GB)

(21) Appl. No.: 18/278,481

(22) PCT Filed: Mar. 2, 2022
(86) PCT No.: PCT/US2022/018419

§ 371 Date: Aug. 23, 2023

Related U.S. Application Data
(60) Provisional application No. 63/157,928, filed on Mar. 8, 2021.

(51) Int. Cl. G06F 3/04815; G06F 3/01; G06F 8/34; G06F 9/451

(52) U.S. Cl. CPC G06F 3/04815; G06F 3/011; G06F 3/017; G06F 8/34; G06F 9/451

(57) ABSTRACT

An exemplary process presents a first set of views having a first set of options for using content in a 3D environment, wherein the first set of views are provided from a first set of viewpoints, determines to present a second set of for using the content in the 3D environment based on user interaction data, wherein the second set of options includes fewer options than the first set of options and in accordance with determining to present the second set of options, presents a second set of views including the second set of options, wherein the second set of views are provided from a second set of viewpoints in the 3D environment.

### TECHNICAL FIELD

The present disclosure generally relates to integrated development environments, particularly integrated development environments for development of three-dimensional immersive content.

### BACKGROUND

Integrated development environments (IDEs) provide user interfaces for developing and debugging computer-executable content. Existing IDEs may not be optimized for developing and debugging content for use in immersive three-dimensional environments. Existing IDEs may not adequately facilitate a user (e.g., app creator, developer, programmer, debugger, etc.) in developing and testing immersive content.

### SUMMARY

Various implementations disclosed herein include devices, systems, and methods that provide an IDE for developing and/or debugging content for use in three-dimensional (3D) environments such as extended reality (XR) environments. Controls for the IDE (e.g., to run, edit, debug code, etc.) may be presented as (i) a first set of options (e.g., a full set of controls for the IDE) or (ii) a second set of options (e.g., an IDE mini-player having a reduced set of controls for the IDE). In some implementations, the first set of options may be anchored within the 3D environment while the second set of options may be variably positioned (e.g., based on the user's hand) and/or provided based on context (e.g., whether the user is running, editing debugging code, etc.). In an exemplary use case, an anchored user interface can provide a full set of IDE features for a user working on XR content. The user may be able to get up and walk around to inspect the content or play the content in a 3D position that is away from the full set of IDE features. While away from the full set of IDE features, the user may use the mini-player's second set of options to access some IDE features without having to return to the location that the full set of IDE features was anchored. In some implementations, a mini-player is displayed only if the first set of options is not in view. Additionally, or alternatively, the mini-player may provide an option to relocate the first (e.g., full) set of options to the current location.

In general, one innovative aspect of the subject matter described in this specification can be embodied in methods that include the actions of presenting a first set of views having a first set of options for using content in a 3D environment, where the first set of views are provided from a first set of viewpoints, determining to present a second set of options for using the content in the 3D environment based on user interaction data, where the second set of options includes fewer options than the first set of options, and in accordance with determining to present the second set of options, presenting a second set of views including the second set of options, wherein the second set of views are provided from a second set of viewpoints in the 3D environment.

These and other embodiments can each optionally include one or more of the following features.

In some aspects, the presenting of the second set of options occupies less space than the presenting of the first set of options. In some aspects, the first set of options are anchored to a particular location within the first set of views.

In some aspects, the method further includes discontinuing presentation of the first set of options in accordance with determining to present the second set of options.

In some aspects, options included in the second set of options are based on a context of the first set of views. In some aspects, options included in the second set of options includes enabling a display of a bounding box corresponding to a detected object. In some aspects, options included in the second set of options includes enabling a display of a surface mesh corresponding to detected surfaces within the second set of views.

In some aspects, the first set of options are anchored to a particular location and the second set of options include an option to reposition the anchored first set of options based on the user interaction data. In some aspects, the second set of options are displayed on a user's hand and determining to present a second set of options based on the user interaction data includes detecting an interaction based on a user touching a corresponding portion of the user's hand.

In some aspects, the first set of views and the second set of views change responsive to movement of a display or a system that the first set of views are presented thereon. In some aspects, determining to present the second set of options is based on determining, based on the movement of the display of the system that the first set of views are presented thereon, that the first set of options is not in view or that less than a percentage of the first set of options is in view.

In some aspects, the first set of views includes an IDE that includes programming code for an object. In some aspects, the second set of views displays the object and introspection options associated with the object. In some aspects, determining to present the second set of options is based on a relative position of the first set of options and the device. In some aspects, determining to present the second set of options is based on detecting that the user's hand is with view of the user's viewpoint.

In some aspects, presenting the views of the 3D environment includes presenting video pass-through or see-through images of at least a portion of a physical environment, wherein a 3D reconstruction of at least the portion of the physical environment is dynamically generated. In some aspects, the first and second sets of views are presented on a head-mounted device (HMD).

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is an example of a device used within a physical environment in accordance with some implementations.

FIGS. 2A-2C illustrate example views provided by the device of FIG. 1, the views including an integrated development environment within the physical environment in accordance with some implementations.

FIG. 3 illustrates an example view provided by the device of FIG. 1, the view including a limited set of IDE options within the physical environment in accordance with some implementations.

FIG. 4 illustrates an example view provided by the device of FIG. 1, the view including a limited set of IDE options within the physical environment in accordance with some implementations.

FIG. 5 is a flowchart representation of an exemplary method that determines and presents a second set of options based on user interaction data within a 3D environment in accordance with some implementations.

FIG. 6 is a system flow diagram of an example environment in which a system can integrate an integrated development environment and content within a 3D environment in accordance with some implementations.

FIG. 7 is an example device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous specific details are provided herein to afford those skilled in the art a thorough understanding of the claimed subject matter. However, the claimed subject matter may be practiced without these details. In other instances, methods, apparatuses, or systems, that would be known by one of ordinary skill, have not been described in detail so as not to obscure claimed subject matter.

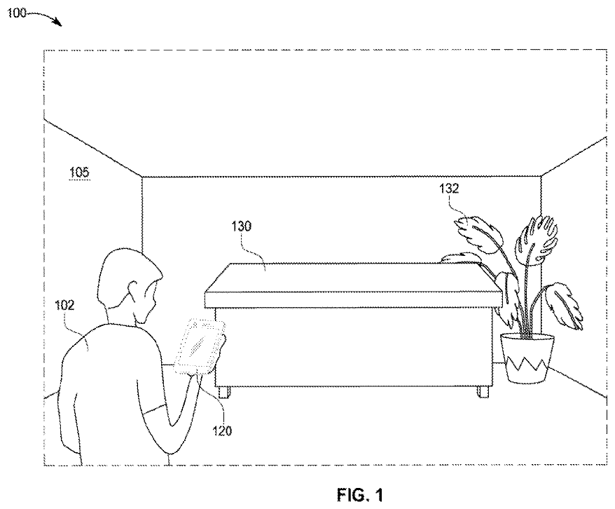

FIG. 1 illustrates an exemplary operating environment 100 in accordance with some implementations. In this example, the example operating environment 100 involves an exemplary physical environment 105 that includes physical objects such as desk 130 and plant 132. Additionally, physical environment 105 includes user 102 holding device 120. In some implementations, the device 120 is configured to present a computer-generated environment to the user 102. The presented environment can include extended reality features.

In some implementations, the device 120 is a handheld electronic device (e.g., a smartphone or a tablet). In some implementations, the device 120 is a near-eye device such as a head worn device. The device 120 utilizes one or more display elements to present views. For example, the device 120 can display views that include an integrated development environment (IDE) in the context of an extended reality environment. In some implementations, the device 120 may enclose the field-of-view of the user 102. In some implementations, the functionalities of device 120 are provided by more than one device. In some implementations, the device 120 communicates with a separate controller or server to manage and coordinate an experience for the user. Such a controller or server may be located in or may be remote relative to the physical environment 105.

People may sense or interact with a physical environment or world without using an electronic device. Physical features, such as a physical object or surface, may be included within a physical environment. For instance, a physical environment may correspond to a physical city having physical buildings, roads, and vehicles. People may directly sense or interact with a physical environment through various means, such as smell, sight, taste, hearing, and touch. This can be in contrast to an extended reality (XR) environment that may refer to a partially or wholly simulated environment that people may sense or interact with using an electronic device. The XR environment may include virtual reality (VR) content, mixed reality (MR) content, augmented reality (AR) content, or the like. Using an XR system, a portion of a person's physical motions, or representations thereof, may be tracked and, in response, properties of virtual objects in the XR environment may be changed in a way that complies with at least one law of nature. For example, the XR system may detect a user's head movement and adjust auditory and graphical content presented to the user in a way that simulates how sounds and views would change in a physical environment. In other examples, the XR system may detect movement of an electronic device (e.g., a laptop, tablet, mobile phone, or the like) presenting the XR environment. Accordingly, the XR system may adjust auditory and graphical content presented to the user in a way that simulates how sounds and views would change in a physical environment. In some instances, other inputs, such as a representation of physical motion (e.g., a voice command), may cause the XR system to adjust properties of graphical content.

Numerous types of electronic systems may allow a user to sense or interact with an XR environment. A non-exhaustive list of examples includes lenses having integrated display capability to be placed on a user's eyes (e.g., contact lenses), heads-up displays (HUDs), projection-based systems, head mountable systems, windows or windshields having integrated display technology, headphones/earphones, input systems with or without haptic feedback (e.g., handheld or wearable controllers), smartphones, tablets, desktop/laptop computers, and speaker arrays. Head mountable systems may include an opaque display and one or more speakers. Other head mountable systems may be configured to receive an opaque external display, such as that of a smartphone. Head mountable systems may capture images/video of the physical environment using one or more image sensors or capture audio of the physical environment using one or more microphones. Instead of an opaque display, some head mountable systems may include a transparent or translucent display. Transparent or translucent displays may direct light representative of images to a user's eyes through a medium, such as a hologram medium, optical waveguide, an optical combiner, optical reflector, other similar technologies, or combinations thereof. Various display technologies, such as liquid crystal on silicon, LEDs, uLEDs, OLEDs, laser scanning light source, digital light projection, or combinations thereof, may be used. In some examples, the transparent or translucent display may be selectively controlled to become opaque. Projection-based systems may utilize retinal projection technology that projects images onto a user's retina or may project virtual content into the physical environment, such as onto a physical surface or as a hologram.

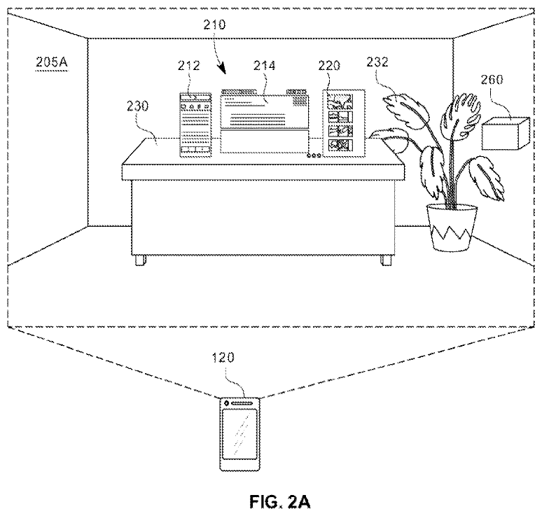

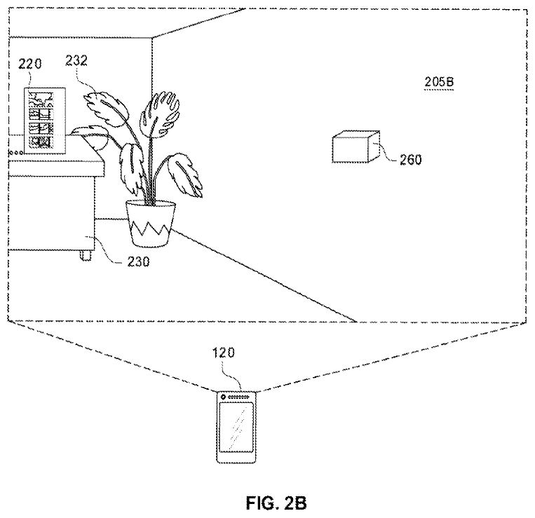

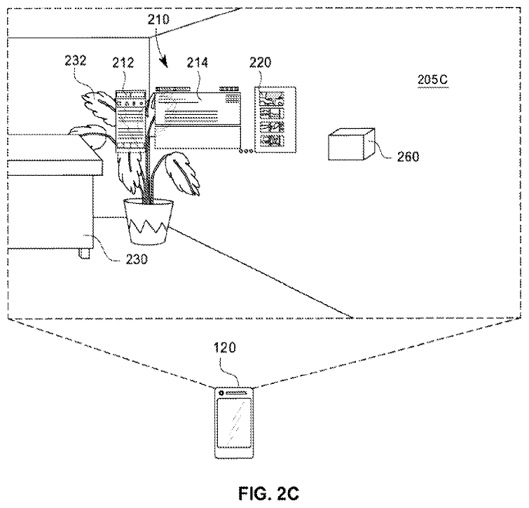

FIGS. 2A-2C illustrate exemplary views provided by the display elements of device 120. The views present an XR environment that includes aspects of an IDE and aspects of a physical environment (e.g., environment 105 of FIG. 1). The first view 205A, depicted in FIG. 2A, provides a view of the physical environment 105 from a particular viewpoint facing the desk 130. Accordingly, the first view 205A includes a representation 230 of the desk 130 and a representation 232 of the plant 132 from that viewpoint. The second view 205B and third view 205C, depicted in FIGS. 2B and 2C, respectively, provide views of the physical environment 105 from a different viewpoint, facing a portion of the physical environment 105 to the right of the desk 130. Desk representation 230 and plant representation 232 are visible in the second view 205B and third view 205C, but at different locations (compared to the first view 205A) based on the different viewpoints.

The views 205A-C include content that correspond to features of IDE 210 (e.g., IDE window-1 212 and IDE window-2 214) and content being developed via the IDE 210. For example, exemplary IDE window-1 212 presents multiple portions (e.g., windows, features, controls, etc.), including controls for a code compiler, a code interpreter, a class browser, an object browser, a class hierarchy diagram, so forth, for use in software development. The exemplary IDE window-2 214 presents a source code editor as a coding interface. The coding interface within the IDE window-2 214 may allow the user to make changes directly to the code either during execution of the content 220 or while displaying the content 220 at a particular time (e.g., a particular time an error occurs). During a debugging session, a user may utilize the IDE 210 for debugging, using an integrated debugger, with support for setting breakpoints in the editor, visual rendering of steps, etc.

Optionally, the IDE 210 and/or the content 220 being developed include multiple portions (e.g., windows, panes, other virtual objects) that may be selected and moved by the user or the system in any 3D location within the viewing environment. For example, the user may have positioned IDE 210 (e.g., at a 3D position) above the desk representation 230. Similarly, the device 120 may enable the user to control or specify a preference regarding positioning of the IDE 210 and/or the content 220 being developed, e.g., whether the IDE content will be fixed in a 3D position always, fixed in a 3D position until a condition is satisfied, or provided at a fixed device location, as examples.

Optionally, the content 220 being developed corresponds to or includes a 3D content. For example, the content 220 being developed may be executed or otherwise played to provide one or more static, moving, or interactive 3D objects. The views provided by device 120 may provide a separate representation of a 3D depiction of the content 220 being developed (i.e., virtual object 260). For example, the views may include the content 220 in a preview application window that presents a 2D depiction of a basketball, and a 3D depiction of a virtual object 260 representing the basketball. The view may present only a 2D view of content being developed, only a 3D view of content being developed, or both a 2D view and a 3D view. Moreover, the content being developed may include both 2D portions and 3D portions. For example, the content being developed may be an application that has a 2D user interface that includes one or more 3D objects. The view may provide the 2D portions in a 2D preview window and present the 3D portions using one or more 3D representations.

Optionally, the device 120 may enable the user to inspect the 3D depiction of the virtual object 260. The device may enable inspection of the 3D depiction of the virtual object 260 from different viewpoints, for example, by fixing the 3D location of the virtual object 260 relative to the physical environment 105 and enabling the user to move around and view different sides of the 3D depiction of the virtual object 260 from different viewing positions. The ability to inspect such a virtual object 260 during development may facilitate, simplify, and improve the efficiency of the development process. The content 220 being developed may have time-based and/or include interactive features (e.g., video content, user interface content, interactive 3D objects, media content, etc.) and the view may facilitate playing, testing, and/or debugging such features. For example, a preview window may enable a user to play and view a time-based 2D portion of the content. As another example, the virtual object 260 may respond to interaction according to response behaviors specified in the content 220 being developed, e.g., responding to user input that causes the virtual object 260 to move downward and appear to bounce off of the depiction of the physical environment floor.

Optionally, the IDE 210 and/or content 220 being developed is positioned to appear at particular 3D locations within the 3D environment. For example, as illustrated, the content may include IDE 210 (e.g., IDE window-1 212 and IDE window-2 214) and content 220 (e.g., a virtual multimedia application program) depicted at a 3D location within the physical environment. In the example of FIG. 2A, the IDE 210 and content 220 being developed are depicted in a way that they appear to be positioned at a 3D position above the desk representation 230.

Optionally, the content (e.g., the IDE 210) is presented in an anchored 3D position relative to the physical environment 105. The content thus appears in a fixed 3D position in the mixed reality environment for different views from different viewpoints. For example, as illustrated in FIG. 2A, the IDE 210 and/or the content 220 being developed are displayed above the desk representation 230 at respective locations on the display of the device 120 based on defined 3D coordinate locations relative to a 3D environment, e.g., a coordinate system based on the physical environment 105. Views from different viewpoints may be based on those fixed 3D coordinate locations and thus the IDE 210 and the content 220 being developed may appear to be anchored (e.g., above the desk representation 230) in the physical environment 105. As a user changes the viewpoint, e.g., by moving the device 120 while working on developing content 220 using the IDE 210, the IDE 210 and content 220 being developed remain anchored above the desk representation 230. Thus, if the device 120 is moved to a different viewpoint (e.g., a user moves his or her head while wearing an HMD), the IDE 210 and content 220 being developed remain anchored above the desk representation 230 in the views provided by the device 120.

Optionally, the IDE 210 and content 220 being developed remain anchored relative to the 3D environment regardless of context, e.g., regardless of how much the viewpoint changes. For example, FIG. 2B illustrates the second view 205B of the device 120 from a facing the portion of the physical environment 105 to the right of desk representation 230 that is significantly different than the viewpoint corresponding to the first view 205A. In spite of the difference in viewpoints, the IDE 210 and content 220 being developed remain anchored to the same 3D coordinate location (e.g., anchored above the desk representation 230). The IDE 210 and 220 content may not be visible in a view at all when the viewpoint changes sufficiently, e.g., when the user turns the device to face backwards relative to its original viewpoint. In such circumstances, the user will need to change the viewpoint back, e.g., by looking back towards the desk, to again view and interact with the IDE 210 and content 220 being developed.

Optionally, the IDE 210 and/or the content 220 being developed remains anchored until a condition is satisfied, e.g., the viewpoint changes more than a threshold, at which point, the content is repositioned at a new anchored position or transitioned to be anchored to a pixel location on the display rather than to a 3D location. For example, the IDE 210 and/or the content 220 may be repositioned automatically based on determining that the IDE 210 and/or the content 220 are no longer visible in the current view.

Optionally, the IDE 210 and/or the content 220 being developed are anchored to a pixel location on a display of the device 120 and thus not anchored to the same 3D coordinate location relative to the 3D environment. Thus, as the device 120 is moved through a series of different viewpoints (e.g., as a user moves his or her head while wearing an HMD), the IDE 210 and content 220 being developed would not remain anchored above the desk representation 230. Instead, the IDE 210 and content 220 being developed may be anchored to the same pixel location on the display of the device 120 and thus appear to move with the user as he or she moves or re-orients the device. For example, FIG. 2C illustrates another view from the same viewpoint as in FIG. 2B (e.g., facing a portion of the physical environment 105 the right of the desk). However, rather than remaining fixed above the desk representation 230, the IDE 210 and content 220 remain positioned at the center of the view (similar to view 205A). Such a device-fixed view may be provided based on the IDE 210 and content 220 being anchored to the pixel location on the display of the device 120, rather than being anchored to 3D coordinate location.

It can be advantageous to position the IDE 210 and/or the content 220 at an anchored position relative to a physical environment, e.g., above the desk representation 230, and to provide alternative mechanisms for a user to access some or all of the IDE 210 features when the IDE 210 (e.g., in its anchored 3D location) is not visible and/or easily accessible from the user's current viewpoint. For example, a first set of views having a first set of IDE options (e.g., IDE 210) may be provided in views corresponding to a first set of viewpoints (e.g., while the user is near the desk 130 and looking in the direction of the IDE 210). A second set of views having a second (e.g., limited) set of IDE option may be provided in views corresponding to a second set of viewpoints (e.g., while the user far from the desk and/or looking in another direction). Such display of different sets of full and limited IDE options may facilitate the development, playing, testing, and/or debugging of content using an IDE in a 3D environment.

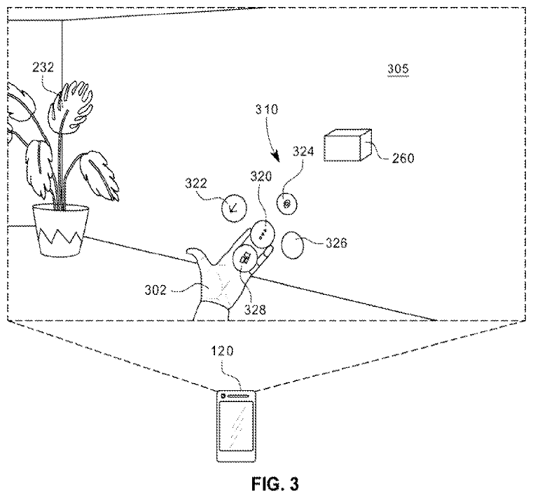

FIG. 3 illustrates an example view 305 provided by the device 120. The view includes a limited set of IDE options, e.g., an IDE mini-player 310, within the physical environment 105. The view 305 may, for example, be presented when a user moves to view virtual object 260 (e.g., a 3D depiction of the content 220 being developed) from a different position. The view 305, depicted in FIG. 3, provides a view of the physical environment 105 from a particular viewpoint, i.e., a viewpoint facing a portion of the physical environment 105 to the right of the plant 132. Accordingly, the view 305 includes a plant representation 232 from that viewpoint. At least a portion of the IDE 210 of FIGS. 2A-C is not visible and/or is not easily accessible from this viewpoint.

The IDE mini-player 310 included in the view 305 includes a plurality of control options (e.g., control icons 320, 322, 324, 326, 328). In this example, control icon 320, when initiated, displays additional control icons. Control icon 322, when initiated, closes the current view of control icons (e.g., discontinuing the display of the other icons). Control icon 324, when initiated, presents the user with a different viewpoint of the content being developed. Control icon 326, when initiated, presents multiple pieces of content being developed simultaneously. For example, the content being developed may include several different levels of windows that may be presented simultaneously during programming/debugging.

The number of IDE controls (e.g., control icons 320, 322, 324, 326, 328) provided and/or which IDE controls are provided may be determined based upon context. The context may include, among other things, the current development activity (e.g., whether the user is currently designing, coding, playing, testing, debugging, etc.), the user's position or movement, the type of the content being developed, the controls frequently or recently used by the user, the user's preferences, etc. The IDE mini-player 310 may adapt over time based on detecting context changes. For example, based on movement of the user, the IDE mini-player 310 may minimize to one icon (e.g., icon 320) or only presents the user with a small set of the controls.

The configuration of the IDE mini-player 310 IDE controls may be selected and provided based on user interaction. In some examples, the different control features are selected based on the position, configuration, and/or gesture of a hand of the user. As a specific example, based on detecting, as illustrated in FIG. 3, that the user's hand 302 is stationary and/or that the user's hand 302 is open with palm up, the device 120 may determine to present the illustrated set of control icons 320, 322, 324, 326, 328. In contrast, based on detecting that the user's hand 302 is not stationary or detecting that the user's hand 302 corresponds to a closed first, these control icons 320, 322, 324, 326, 328 may be hidden from view.

In FIG. 3, the IDE mini-player 310 presents a limited set of features that are potentially applicable during a specific development activity (e.g., while executing or playing content that is being developed) via the icons 320, 322, 324, 326, 328. The presented set of features may additionally provide access to less limited IDE features. For example, control icon 328, when initiated, may execute IDE coding features and/or initiate the display of other interface features (e.g., IDE window-1 212 and/or IDE window-2 214 of FIGS. 2A-C).

The device 120 may position and move the IDE mini-player 310 to enhance the user experience. In FIG. 3, the IDE mini-player 310 is partially overlaid over and anchored to the user's hand 302 (e.g., user 102 of FIG. 1). As the user's hand 302 moves, the IDE mini-player 310 and each control icon 320, 322, 324, 326, 328 is moved with the user's hand. The IDE mini-player 310 and individual control icons of the IDE mini-player 310 may be anchored based on a 3D location within the physical environment 105. In some implementations, the device 120 may be configured to anchor the IDE mini-player 310 to a particular physical object (e.g., the user's arm, notebook, tablet, etc.) within the physical environment 105. Alternatively, the views of IDE mini-player 310 and associated control icons (e.g., control icons 320, 322, 324, 326, 328) may be anchored to a fixed device position, e.g., fixed in the lower left corner of the display of the device 120.

Interactions with the control icons 320, 322, 324, 326, 328 may be based on detecting user movements and/or via an input device. In some examples, a function or feature associated with an icon is initiated responsive to detecting a corresponding user gesture, e.g., the user positioning a finger at a 3D location corresponding to a 3D location at which the respective control (e.g., icon) is positioned. In some examples, a function or feature associated is initiated responsive to detecting a touch on a touch-sensitive surface operatively coupled to device 120, e.g., the controls may be displayed on a separate device or virtually displayed to appear over a touch screen of another device. In some examples, a function or feature associated with a control is initiated responsive to detecting a click on an input device (e.g., a mouse, stylus, joystick, or other hand-held or hand operated control device) operatively coupled to device 120.

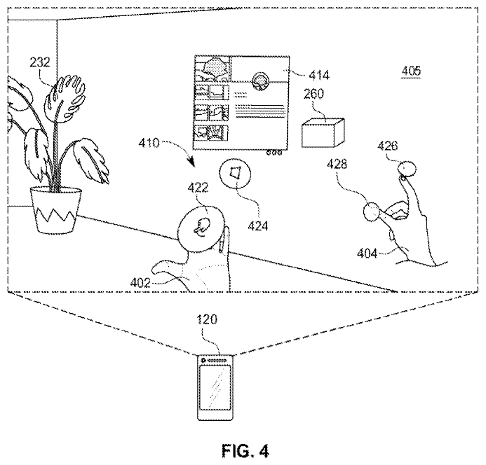

FIG. 4 illustrates an example view 405 provided by the device of FIG. 1. The view 405 including a limited set of IDE options (e.g., IDE mini-player 410) within the physical environment 105. The view 405, depicted in FIG. 4, provides a view of the physical environment 105 from a particular viewpoint, i.e., a viewpoint facing a portion of the physical environment 105 to the right of the plant 132. Accordingly, the view 405 includes a plant representation 232 from that viewpoint. At least a portion of the IDE 210 of FIGS. 2A-C is not visible and/or is not easily accessible from this viewpoint.

The view 405 includes a depiction of content being developed, i.e., the application program 414, virtual object 260 depicting the 3D appearance of content being developed, and control options (e.g., control icons 422, 424, 426, and 428) of an IDE min-player 410. The control options may provide IDE functions and features, including functions and features for playing, interacting with, testing, and/or debugging the application program 414 and/or virtual object 260. Control icon 422, when initiated/clicked/tapped, closes the current view of control icons. Control icon 424, when initiated/clicked/tapped, executes the coding features and/or coding interfaces (e.g., IDE window-1 212 and/or IDE window-2 214 of FIG. 2). Control icons 426 and 428, as illustrated, enable the user to interact with the application program 414 (e.g., interacting with the multimedia within the application).

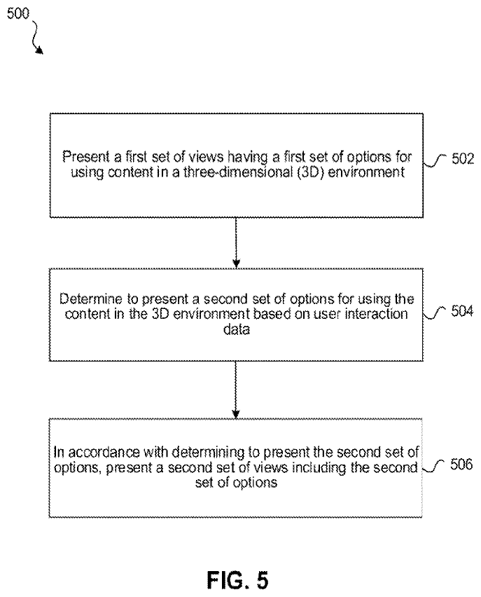

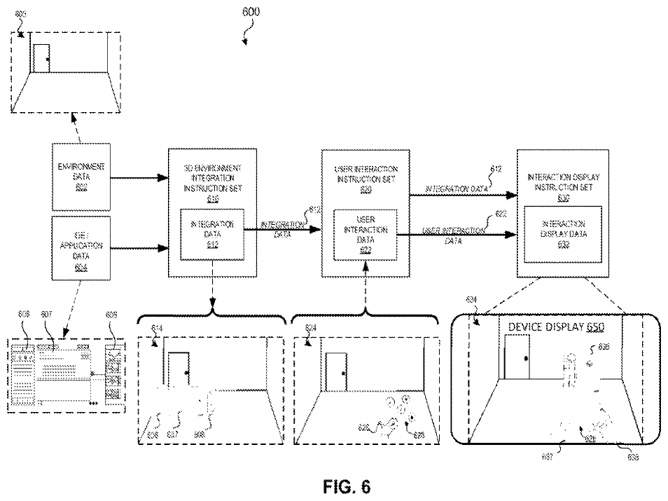

FIG. 5 is a flowchart representation of an exemplary method 500 that determines and presents a second set of options (e.g., an IDE mini-player) based on user interaction data within a 3D environment (e.g., an XR environment) in accordance with some implementations. In some implementations, the method 500 is performed by a device (e.g., device 120 of FIG. 1), such as a mobile device, desktop, laptop, or server device. In some implementations, the device has a screen for displaying images and/or a screen for viewing stereoscopic images such as a head-mounted display (HMD). In some implementations, the method 500 is performed by processing logic, including hardware, firmware, software, or a combination thereof. In some implementations, the method 500 is performed by a processor executing code stored in a non-transitory computer-readable medium (e.g., a memory). The content presentation process of method 500 is illustrated with examples with reference to FIGS. 2-4 and illustrated as a system flow diagram with reference to FIG. 6.

At block 502, the method 500 presents a first set of views having a first set of options (e.g., full set of IDE controls) for using content in a 3D environment, wherein the first set of views are provided from a first set of viewpoints (e.g., based on the position of the user's device) in the 3D environment. For example, views of the IDE may be presented in an anchored position above a user's desk as the user sits and works on developing an app that will provide the content. In some implementations, during execution of the application, the views of the scene are presented on an HMD.

Optionally, the first set of options are anchored to a particular location within the first set of views. For example, as illustrated in FIG. 3, the IDE mini-player 310 and each control icon 320, 322, 324, 326, 328 moves with the user's hand since it is anchored to the user's hand 302.

At block 504, the method 500 determines to present a second set of options (e.g., a mini-player with a reduced set of options) for using the content in the 3D environment based on user interaction data. In some implementations, the second set of options includes fewer options than the first set of options. For example, presenting a second set of options (e.g., IDE mini-player 310 of FIG. 3) based on user interaction data may be based on determining that the first set of options is not in view or that less than a percentage of the first set of options is in view. In some implementations, the user interaction data may be based on the relative positions of the first set of options and the user (e.g., a distance between the user 102 and the anchored position of the IDE 210).

Additionally, or alternatively, the user interaction data may be based on particular user motions. For example, finger tapping may initiate particular control icons (e.g., a particular subset of controls). Additionally, or alternatively, the user interaction data may be based on the user looking at his/her hand. For example, the control icons for the IDE mini-player 310 may be only visualized if the user glances at (e.g., briefly looks down), or stares at (looks at for a threshold length of time such as two seconds), his or her hand (e.g., hand 302). In some implementations, the user interaction data may be based on detecting that the user's hand in view. For example, whether or not the user looks at his or her hand, if the user brings his or her hand within the peripheral view, such as the scene illustrated in example view 305, then the IDE mini-player 310 and associated control icons may be displayed.

Optionally, the presenting of the second set of options occupies less space (e.g., less of the view) than the presenting of the first set of options. In some implementations, options included in the second set of options are based on a context of the first set of views.

Optionally, options included in the second set of options includes debugging tools. The IDE mini-player 310 may include a plurality of control options for the IDE. For example, control options could include enabling collision shapes, or enabling bounding volumes of applications (e.g., displaying bounding boxes for each detected object). Additionally, control options for the IDE could include enabling a display of a surface mesh corresponding to detected surfaces within the second set of views (e.g., showing an occlusion mesh). Control options for the IDE could further include an option for displaying all walls and floors found by an XR kit, and the like. Additionally, options included in the second set of options may include IDE mini-player 410 that includes a plurality of control options for and turning on curser locations of fingers to interact with application program 414.

Optionally, the first set of options are anchored to particular location and the second set of options include an option to reposition the anchored first set of options based on the user interaction data. For example, as illustrated in FIG. 3, IDE mini-player 310 is anchored to a current position of a user's hand 302.

At block 506, the method 500, in accordance with determining to present the second set of options, presents a second set of views including the second set of options. In some implementations, the second set of views are provided from a second set of viewpoints in the 3D environment. For example, as illustrated in FIG. 3 for the control icons associated with the IDE mini-player 310, the second set of options (e.g., the control icons) may be positioned based on a position of a user's hand (e.g., on or above the user's hand).

Optionally, the method 500 involves discontinuing presentation of the first set of options in accordance with determining to present the second set of options. For example, the control options for the IDE mini-player are determined to be presented, the IDE 210 (e.g., IDE window-1 212 and IDE window-2 214) are removed from view of the user. For example, when a user's moves within the physical environment, the IDE 210 would discontinue (e.g., the user is wearing an HMD, but wants to get up and take a break so the IDE 210 disappears from view).

Optionally, the second set of options are displayed on a user's hand (e.g., IDE mini-player 310 and associated control icons as illustrated in FIG. 3 on user's hand 302), and determining to present a second set of options is based on the user interaction data includes detecting an interaction based on a user touching a corresponding portion of the user's hand. For example, the IDE mini-player 310 may be minimized (e.g., only shows one icon or no icons are shown in the user's view), and the user may make a particular motion such that when that particular user motion is detected, the IDE mini-player 310 and associated control icons are then displayed, as illustrated in FIG. 3. For example, a particular motion the user may make could include a user tapping their fingers with their thumb like a pinching motion, touching one hand with their opposite hand, or some other type of hand movement the device 120 can detect and determine the control the user initiated.

Optionally, the method 500 further involves determining to present the second set of options based on determining that the first set of options is not in view or that less than a percentage of the first set of options is in view. For example, if user's is looking away and less than 50% of the IDE (e.g., IDE 210 of FIG. 2) is within view, then the full set of controls minimizes to the mini-player (e.g., IDE mini-player 310 of FIG. 3).

Optionally, the first set of views includes an IDE that includes programming code for an object. In some implementations, the second set of views displays the object and debugging and/or introspection options associated with the object. In some implementations, the second set of views displays less than a threshold portion of the IDE. For example, the IDE mini-player 310 becomes a smaller version of mini-player (e.g., only shows control icon 320 on the user's hand 302) when the user's hand 302 starts to be moved outside the view of the user, such as when 50% or more of the hand is removed from view, then the IDE mini-player 310 displays less of the control icons, or disappears completely.

Optionally, the first set of views and the second set of views change responsive to movement of a display or a system that the first set of views and/or the second set of views are presented thereon. For example, if a user is working within an XR environment within the IDE and decides to get up to take a break, the set of views would automatically change. For example, the IDE windows (e.g., IDE windows 212, 214) would minimize within the content player.

Optionally, presenting the views of the 3D environment includes presenting video pass-through or see-through images of at least a portion of a physical environment, wherein a 3D reconstruction of at least the portion of the physical environment is dynamically generated.

Optionally, the user may pause the test and use a scrubber tool to go back to view a desired point in time. In some implementations, the user may playback from the same viewpoint or, alternatively, the user may change the viewpoint and see depictions of where the HMD was, such as based on the gaze direction. In some implementations, the user may change the viewpoint to observe scene understanding, (e.g., head position, hand position, 3D reconstruction mesh, etc.). In some implementations, a user may go back to enable display of representations of sound sources (e.g., spatialized audio) and other invisible items. In some implementations, a user may add data tracks.

The presentation of a second set of views including an IDE mini-player with a subset of options for IDE controls within the 3D environment is described herein with reference to FIGS. 2-4 and further described herein with reference FIG. 6. In particular, FIGS. 2-4 illustrate examples of views presented to a user working with an IDE controls with a full set of controls and/or a mini-player for the IDE with a subset of controls to program/debug an application (e.g., virtual application overlaid on a physical environment, i.e., pass-through video). FIG. 6 illustrates a system flow diagram that illustrates an integration of an IDE environment (e.g., full set of controls and/or a mini-player) with content within a 3D environment in accordance with techniques described herein.

FIG. 6 illustrates a system flow diagram of an example environment 600 in which a system can present a view that integrates an integrated development environment and content within a 3D environment according to some implementations. In some implementations, the system flow of the example environment 600 is performed on a device (e.g., device 120 of FIG. 1), such as a mobile device, desktop, laptop, or server device. The images of the example environment 600 can be displayed on the device that has a screen for displaying images and/or a screen for viewing stereoscopic images such as a HMD. In some implementations, the system flow of the example environment 600 is performed on processing logic, including hardware, firmware, software, or a combination thereof. In some implementations, the system flow of the example environment 600 is performed on a processor executing code stored in a non-transitory computer-readable medium (e.g., a memory).

The system flow of the example environment 600 acquires environment data 602 (e.g., image data) from sensors of a physical environment (e.g., the physical environment 105 of FIG. 1), and acquires IDE/application data 604 from an IDE (e.g., IDE 210 of FIG. 2) and an application program (e.g., content 220 of FIG. 2), integrates the environment data 602 and the IDE/application data 604, obtains user interaction data (e.g., a user interacting with IDE controls), and generates interactive display data for a user to view an IDE (e.g., an IDE mini-player) and/or execution of the application program (e.g., to identify an occurrence of an error, if any). For example, an IDE mini-player technique described herein can allow a user wearing an HMD, for example, to be able to get up and walk away to inspect the content or play the content in environments located further away, and use the IDE mini-player's second set of options to access some options without having to return to the location that the IDE was anchored.

In an example implementation, the environment 600 includes an image composition pipeline that acquires or obtains data (e.g., image data from image source(s)) of the physical environment from a sensor on a device (e.g., device 120 of FIG. 1). Example environment 600 is an example of acquiring image sensor data (e.g., light intensity data, depth data, and position information) for a plurality of image frames. For example, image 603 represents a user acquiring image data as the user is in a room in a physical environment (e.g., the physical environment 105 of FIG. 1). The image source(s) may include a depth camera that acquires depth data of the physical environment, a light intensity camera (e.g., RGB camera) that acquires light intensity image data (e.g., a sequence of RGB image frames), and position sensors to acquire positioning information. For the positioning information, some implementations include a visual inertial odometry (VIO) system to determine equivalent odometry information using sequential camera images (e.g., light intensity data) to estimate the distance traveled. Alternatively, some implementations of the present disclosure may include a SLAM system (e.g., position sensors). The SLAM system may include a multidimensional (e.g., 3D) laser scanning and range measuring system that is GPS-independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location. The SLAM system may further be a visual SLAM system that relies on light intensity image data to estimate the position and orientation of the camera and/or the device.

In the example implementation, the environment 600 includes an application data pipeline that acquires or obtains IDE/application data (e.g., IDE/application data from IDE/application program source(s)). For example, the IDE/application data 604 may include IDE windows 606, 607 (e.g., IDE window-1 212 and IDE window-2 214 of FIG. 2), and content 608 (e.g., content 220 of FIG. 2). The IDE/application data 604 may include 3D content (e.g., virtual objects) and user interaction data (e.g., haptic feedback of user interactions with the IDE and application).

In an example implementation, the environment 600 includes an 3D environment integration instruction set 610 that is configured with instructions executable by a processor to generate integration data 612. For example, the 3D environment integration instruction set 610 obtains environment data 602 (e.g., image data of a physical environment such as the physical environment 105 of FIG. 1), obtains IDE/application data 604 (e.g., an IDE and a virtual application), integrates the environment data and IDE/application data (e.g., overlays the IDE windows and application onto a 3D representation of the physical environment), and generates integration data 612. For example, the 3D environment integration instruction set 610 analyzes the environment data 602 to generate a 3D representation (video passthrough, optical see through, or a reconstructed virtual room) of the physical environment and integrates the IDE/application data with the 3D representation so that a user, during execution of the application, views the IDE and application as an overlay on top of the 3D representation as illustrated in the example environment 614, that shows IDE windows 606, 607 and an application window for content 608 overlaid on the environment data 602. The integration of the IDE and application program is described herein with reference to FIG. 2.

In an example implementation, the environment 600 further includes a user interaction instruction set 620 that is configured with instructions executable by a processor to acquire the integration data 612 from the 3D environment integration instruction set 610 and obtain user interaction data 632 from user interactions with the IDE and application program. For example, the user interaction instruction set 620 can interaction data of the user during execution of the IDE and the virtual multimedia application program based on user interaction information and changes to the IDE and content that are determined based on user interactions during execution of the application. For example, user interaction information may include scene understandings or snapshots, such as locations of objects in the environment, and user interaction with the controls (e.g., haptic feedback of user interactions such as hand pose information). In particular, as illustrated in the example environment 624, a user's hand 626 is shown as an open palm which may initiate the IDE mini-player 628 with associated IDE controls. The user interaction data with an IDE mini-player and associated IDE controls is described herein with reference to FIGS. 3-4.

In some implementations, a scene understanding may include head pose data, what the user is looking at in the application (e.g., a virtual object), hand pose information, and the like. Additionally, the scene understanding information may include a scene understanding mesh, such as a 3D mesh that is concurrently being generating during execution of the program.

In some implementations, the environment 600 includes an interaction display instruction set 630 that is configured with instructions executable by a processor to assess the integration data 612 from the 3D environment integration instruction set 610 and the user interaction data 622 from the user interaction instruction set 620 and presents a set of views including the IDE (e.g., full set of controls or a mini-player as shown) and/or content within the 3D environment based on the user interaction data 622 (e.g., generates 3D environment 634). In some implementations, the set of views is displayed on the device display 650 of a device (e.g., device 120 of FIG. 1). In some implementations, as illustrated in the example generated 3D environment 634, interaction display instruction set 630 generates interaction display data 632 that includes a user interacting with the IDE mini-player 628 with the user's hands 637 and 638 within the view of the user. For example, if a user is wearing an HMD, the user's left and right hand are being moved within the view of the HMD such that the user can control the IDE controls associated with the presented IDE mini-player to control the interaction with the application program 636. The user interaction data with an IDE mini-player and associated IDE controls is described herein with reference to FIGS. 3-4.

Additionally, a scene understanding may include other data other than visual data. For example, spatialized audio may be part of the content 220. Thus, the system application can play spatialized audio that is produced by the content 220. In some implementations, a visual element (e.g., a virtual icon) may be presented to the user's viewpoint to indicate the location (e.g., the 3D coordinates) of where the spatialized audio is coming from at that moment in time during execution.

In some implementations, the 3D environment, e.g., the scene and other content, may be rendered continuously/live throughout the execution and playback via a scrubber tool. That is the rendering engine can run continuously injecting executing content during one period of time and recorded content at another period of time. In some implementations, playback may be different than simply reconstituting the content in the same way it was originally produced. For example, playback may involve using recorded values for a ball's position (e.g., 3D coordinates) rather than having the ball use the physics system (e.g., in a virtual bowling application). That is the user may pause the test and use a scrubber tool to go back to view a desired point in time.

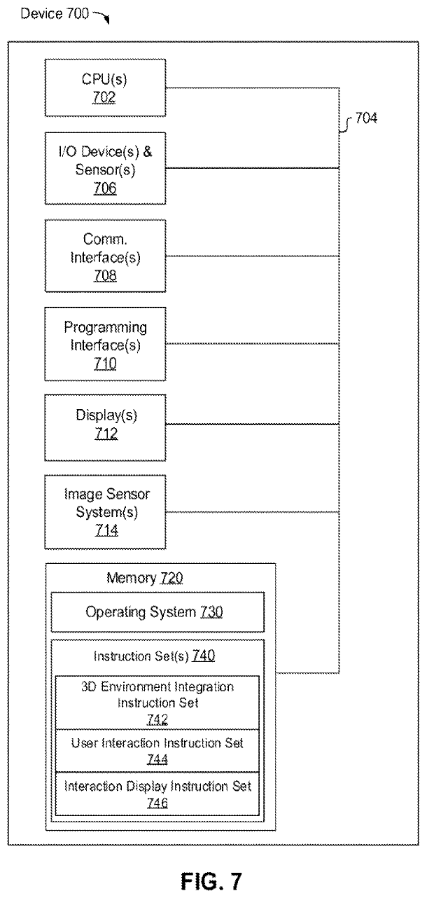

FIG. 7 is a block diagram of an example device 700. Device 700 illustrates an exemplary device configuration for device 120 of FIG. 1. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 700 includes one or more processing units 702 (e.g., microprocessors, ASICs, FPGAs, CPUs, CPUs, processing cores, and/or the like), one or more input/output (I/O) devices and sensors 706, one or more communication interfaces 708 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 710, one or more displays 712, one or more interior and/or exterior facing image sensor systems 714, a memory 720, and one or more communication buses 704 for interconnecting these and various other components.

In some implementations, the one or more communication buses 704 include circuitry that interconnects and controls communications between system components. In some implementations, the one or more I/O devices and sensors 706 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more displays 712 are configured to present a view of a physical environment or a graphical environment to the user. In some implementations, the one or more displays 712 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 712 correspond to diffractive, reflective, polarized, holographic, etc. waveguide displays. In one example, the device 700 includes a single display. In another example, the device 700 includes a display for each eye of the user.

In some implementations, the one or more image sensor systems 714 are configured to obtain image data that corresponds to at least a portion of the physical environment 105. For example, the one or more image sensor systems 714 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 714 further include illumination sources that emit light, such as a flash. In various implementations, the one or more image sensor systems 714 further include an on-camera image signal processor (ISP) configured to execute a plurality of processing operations on the image data.

In some implementations, the device 120 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 10 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 120.

The memory 720 includes high-speed random-access memory, such as DRAM, SRAM, DDR RAM, or other random-access solid-state memory devices. In some implementations, the memory 720 includes non-volatile memory, such as one or more magnetic disk storage devices, optical disk storage devices, flash memory devices, or other non-volatile solid-state storage devices. The memory 720 optionally includes one or more storage devices remotely located from the one or more processing units 702. The memory 720 includes a non-transitory computer readable storage medium.

In some implementations, the memory 720 or the non-transitory computer readable storage medium of the memory 720 stores an optional operating system 330 and one or more instruction set(s) 740. The operating system 730 includes procedures for handling various basic system services and for performing hardware dependent tasks. In some implementations, the instruction set(s) 740 include executable software defined by binary information stored in the form of electrical charge. In some implementations, the instruction set(s) 740 are software that is executable by the one or more processing units 702 to carry out one or more of the techniques described herein.

The instruction set(s) 740 include an 3D environment integration instruction set 742, a user interaction instruction set 744, and a interaction display instruction set 746. The instruction set(s) 740 may be embodied as a single software executable or multiple software executables.

The 3D environment integration instruction set 742 (e.g., 3D environment integration instruction set 610 of FIG. 6) is executable by the processing unit(s) 702 to generate integration data 612. For example, the 3D environment integration instruction set 742 obtains environment data (e.g., image data of a physical environment such as the physical environment 105 of FIG. 1), obtains IDE/application data (e.g., an IDE and application), integrates the environment data and IDE/application data (e.g., overlays the IDE and application onto a 3D representation of the physical environment), records the state changes and scene understanding during execution of the IDE/application, and generates integration data 612. For example, the integration instruction set analyzes the environment data to generate a 3D representation (video passthrough, optical see through, or a reconstructed virtual room) of the physical environment and integrates the IDE and application data with the 3D representation so that a user, during execution of the application, views the IDE and application program as an overlay on top of the 3D representation, as illustrated herein with reference to FIGS. 2-4 and 6.

The user interaction instruction set 744 is configured with instructions executable by a processor to assess the integration data from the 3D environment integration instruction set 742 and obtains and records user interaction data with the IDE controls and/or application program within the 3D environment. For example, the user interaction instruction set 744 can obtain information during the execution of the IDE and application program based on user interaction information and changes to the IDE and content that are determined based on user interactions (e.g., haptic feedback) during execution of the IDE and application programs.

The interaction display instruction set 746 is configured with instructions executable by a processor to assess the integration data from the 3D environment integration instruction set 742 and the user interaction data from the user interaction instruction set 744 and presents a set of views including the IDE (e.g., full set of controls or a mini-player) and/or content within the 3D environment based on the user interaction data. In some implementations, the interaction display instruction set 746 generates interaction display data that includes a user interacting with an IDE mini-player. For example, if a user is wearing an HMD, a user's left and/or right hand can be moved within the view of the HMD such that the user can control the IDE controls associated with the presented IDE mini-player to control the interaction with the IDE and/or application program(s).

Although the instruction set(s) 740 are shown as residing on a single device, it should be understood that in other implementations, any combination of the elements may be located in separate computing devices. Moreover, FIG. 7 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

1. A non-transitory computer-readable storage medium, storing program instructions executable by one or more processors of an electronic device to perform operations comprising:
presenting a first set of views having a first set of options for using content in a three-dimensional (3D) environment, wherein the first set of views are provided from a first set of viewpoints;
determining to present a second set of options for using the content in the 3D environment based on user interaction data, wherein the second set of options comprises fewer options than the first set of options; and
in accordance with determining to present the second set of options, presenting a second set of views comprising the second set of options, wherein the second set of views are provided from a second set of viewpoints in the 3D environment.

2. The non-transitory computer-readable storage medium of claim 1, wherein the presenting of the second set of options occupies less space than the presenting of the first set of options.

3. The non-transitory computer-readable storage medium of claim 1, wherein the first set of options are anchored to a particular location within the first set of views.

4. The non-transitory computer-readable storage medium of claim 1, wherein the operations further comprise discontinuing presentation of the first set of options in accordance with determining to present the second set of options.

5. The non-transitory computer-readable storage medium of claim 1, wherein options included in the second set of options are based on a context of the first set of views.

6. The non-transitory computer-readable storage medium of claim 1, wherein options included in the second set of options comprises enabling a display of a bounding box corresponding to a detected object.

7. The non-transitory computer-readable storage medium of claim 1, wherein options included in the second set of options comprises enabling a display of a surface mesh corresponding to detected surfaces within the second set of views.

8. The non-transitory computer-readable storage medium of claim 1, wherein the first set of options are anchored to a particular location and the second set of options include an option to reposition the anchored first set of options based on the user interaction data.

9. The non-transitory computer-readable storage medium of claim 1, wherein the second set of options are displayed on a user's hand and determining to present a second set of options based on the user interaction data comprises detecting an interaction based on a user touching a corresponding portion of the user's hand.

10. The non-transitory computer-readable storage medium of claim 1, wherein the first set of views and the second set of views change responsive to movement of a display or a system that the first set of views are presented thereon.

11. The non-transitory computer-readable storage medium of claim 10, wherein determining to present the second set of options is based on determining, based on the movement of the display of the system that the first set of views are presented thereon, that the first set of options is not in view or that less than a percentage of the first set of options is in view.

12. The non-transitory computer-readable storage medium of claim 1, wherein the first set of views comprises an integrated development environment (IDE) that includes programming code for an object.

13. The non-transitory computer-readable storage medium of claim 12, wherein the second set of views displays the object and introspection options associated with the object.

14. The non-transitory computer-readable storage medium of claim 1, wherein determining to present the second set of options is based on a relative position of the first set of options and the device.

15. The non-transitory computer-readable storage medium of claim 1, wherein determining to present the second set of options is based on detecting that the user's hand is with view of the user's viewpoint.

16. The non-transitory computer-readable storage medium of claim 1, wherein presenting the views of the 3D environment comprises presenting video pass-through or see-through images of at least a portion of a physical environment, wherein a 3D reconstruction of at least the portion of the physical environment is dynamically generated.

17. The non-transitory computer-readable storage medium of claim 1, wherein the first and second sets of views are presented on a head-mounted device (HMD).

18. A device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the system one or more processors to perform operations comprising:
presenting a first set of views having a first set of options for using content in a three-dimensional (3D) environment, wherein the first set of views are provided from a first set of viewpoints;
determining to present a second set of options for using the content in the 3D environment based on user interaction data, wherein the second set of options comprises fewer options than the first set of options; and
in accordance with determining to present the second set of options, presenting a second set of views comprising the second set of options, wherein the second set of views are provided from a second set of viewpoints in the 3D environment.

19. The device of claim 18, wherein the first set of options are anchored to a particular location and the second set of options include an option to reposition the anchored first set of options based on the user interaction data.

20. A method comprising:
at an electronic device having a processor:
presenting a first set of views having a first set of options for using content in a three-dimensional (3D) environment, wherein the first set of views are provided from a first set of viewpoints;
determining to present a second set of options for using the content in the 3D environment based on user interaction data, wherein the second set of options comprises fewer options than the first set of options; and
in accordance with determining to present the second set of options, presenting a second set of views comprising the second set of options, wherein the second set of views are provided from a second set of viewpoints in the 3D environment.
